(19) United States
(12) Patent Application Publication
(10) Pub. No.: US 2024/0182338 A1
(43) Pub. Date: Jun. 6, 2024

(54) METHOD, APPARATUS, AND SYSTEM FOR AQUATIC MICROPLASTICS REMOVAL

(71) Applicant: PolyGone Systems, Inc., Princeton, NJ (US)

(72) Inventors: Yidian LIU, Princeton, NJ (US); Nathanial BANKS, Princeton, NJ (US); Xi CHEN, Princeton, NJ (US); Muhammad Junaid AMIN, Florence, NJ (US)

(73) Assignee: PolyGone Systems, Inc., Princeton, NJ (US)

(21) Appl. No.: 18/283,604

(22) PCT Filed: Mar. 18, 2022
(86) PCT No.: PCT/US2022/020934

§ 371 Date: Sep. 22, 2023

Related U.S. Application Data
(60) Provisional application No. 63/164,874, filed on Mar. 23, 2021.

(51) Int. Cl. C02F 3/32; C02F 101/30; C02F 103/00; E02B 15/10

(52) U.S. Cl. CPC C02F 3/327; E02B 15/10; C02F 2101/30; C02F 2103/007; C02F 2203/006

(57) ABSTRACT

A method, apparatus, and system are provided, utilize a floating treatment wetland designed specifically for the sequestration of microplastic debris (i.e., plastic particles under 5 mm) from active water systems. This process can be achieved through the careful selection of a root structure combined with the development of a robust housing for the wetland pad, so that it may operate effectively in fast current conditions. Existing phytoremediation wetlands are typically deployed in static aquatic environments like reservoirs or lakes, and cannot remain stable in currents beyond speeds of 2 m/s. This currently limits their application in most rivers that typically reach speeds beyond 6 m/s, especially during storm surges. To overcome this, disclosed is a hydrodynamic fiberglass frame to encase and stabilize the floating treatment wetland during storm surges. The design of this frame may be adapted to encourage optimal flow to the underside of the wetland, in order to maximize the amount of water exposed to the wetland's biofilm filter.

### CROSS-REFERENCE TO RELATED APPLICATIONS

This application claims priority to U.S. Provisional Patent Application 63/164,874, filed Mar. 23, 2021, the entirety of which is incorporated by reference herein.

### BACKGROUND

For over a decade, there has been a concern around the presence of microplastics in water. Microplastics are particles of predominantly synthetic polymeric composition in the micro scale, under 5 mm in size, and generally in the range is between 1 m and 5 mm. While microplastics in relatively still bodies of water (e.g., lakes, reservoirs), microplastics in active bodies of water (rivers, streams, etc.) have been of increasing concern.

To combat the microplastic problem, phytoremediation wetlands have been deployed. However, existing phytoremediation wetlands are typically deployed in static aquatic environments like reservoirs or lakes, and cannot remain stable in currents beyond speeds of 2 m/s. This currently limits their application in active bodies of water, as most rivers typically reach speeds beyond 6 m/s, especially during storm surges.

Further, when existing phytoremediation solutions saturate and are no longer capable of removing microplastics at an acceptable rate, expand to clog up the body of water, or are not otherwise as effective as they could be, such solutions cannot be readily replaced or moved within the body of water.

### BRIEF SUMMARY

To provide for the removal of microplastics from active bodies of water, that allows for ready removal and reconfiguration, a method, apparatus, system, and kit are provided.

In some embodiments, a method for removing microplastics from a body of water is provided. The method may include allowing a body of water comprising microplastics to flow past a root network (which may be a natural root system, an artificial root system, a plurality of filters, or a combination thereof) of at least one apparatus coupled to an anchor; allowing the microplastics to be physically entangled by the root network; and removing the root network from the at least one apparatus. In some embodiments, the method may include replacing the root network after the microplastics have been removed from the root network; and repeating the steps of allowing the water to flow past the root network through replacing the root network. In some embodiments, removing and replacing the root network includes removing and replacing a macroporous layer coupled to the root network. In some embodiments, the method may include removing material physically entangled by the root network. In some embodiments, after removing the material, the method may include performing an analysis of a sample of the material physically entangled by the root network. In some embodiments, after performing the analysis, the method may include repositioning the at least one apparatus based on a result of the analysis.

In some embodiments, an apparatus is provided. The apparatus may include a frame and a root network operably coupled to the frame and extending below the frame. The frame may have a top surface and a bottom surface, the bottom surface of the frame defining at least one anchor point coupled to an anchor, the frame configured to keep at least a portion of the top surface of the frame above a top surface of the body of water. The root network may include: (i) a plurality of roots of long-root plants (such as a sedge, arrow arum, or both) coupled to a macroporous layer, the macroporous layer comprising an array of holes extending from a top surface to a bottom surface, the macroporous layer being removably attached to the frame; (ii) a plurality of non-root natural fibers (such as coir) coupled to a macroporous layer, the macroporous layer comprising an array of holes extending from a top surface to a bottom surface, the macroporous layer being removably attached to the frame; (iii) a plurality of filters (such as 3-15 fiber filters coupled to the frame); or (iv) a combination thereof. In some embodiments, the apparatus may also include a growing medium layer on a top surface of the macroporous layer (which may include, e.g., coir or mineral soils). In some embodiments, the growing medium layer may be a soilless medium. In some embodiments, the apparatus may include at least one tether attached to the at least one anchor point. In some embodiments, a tether may be attached to the anchor.

In some embodiments, the long-root plants or non-root natural fibers are coupled to the macroporous layer via one or more wires. In some embodiments, the macroporous layer is a composite structure, that may include fiberglass, carbon fiber, a wire array, cross-laminated timber, or a combination thereof. In some embodiments, each hole in the array of holes has a diameter of between 0.5 inches and 6 inches. In some embodiments, the plurality of fiber filters are configured such that each fiber filter has a filtration surface that is normal to an expected direction of flow of the body of water, and each fiber filter is offset in a direction parallel to the expected direction of flow of the body of water from at least one other fiber filter by an equal distance.

In some embodiments, the top surface of the frame is configured to have an external geometric shape with 3-8 sides.

In some embodiments, the frame is a composite structure. In some embodiments, the frame may comprise fiberglass, carbon fiber, a cross laminated timber, an inflatable bladder, or a combination thereof. In some embodiments,

In some embodiments, a system is provided. The system may include a plurality of floating platforms positioned in the same body of water, each floating platform being an apparatus as disclosed herein. In some embodiments, each floating platform of the plurality of floating platforms is physically in contact with at least one other floating platform of the plurality of floating platforms. In some embodiments, each floating platform of the plurality of floating platforms is physically separated from all other floating platforms of the plurality of floating platforms. In some embodiments, each floating platform of the plurality of floating platforms is physically separated from at least one other floating platform of the plurality of floating platforms by a distance that is at least half a width of each floating platform and no more than twice the length of each floating platform. In some embodiments, two or more of the plurality of floating platforms are connected via a tether system (which may include, e.g., a wire tether, a hemp rope tether, a polymeric tether, or a combination thereof).

In some embodiments, a kit is provided. The kit may include a frame as disclosed herein, and a root network configured to be operably coupled to the frame and extending below the frame. The frame may be any frame as disclosed herein. The root network may be any root network as disclosed herein. In some embodiments, the kit may also include a macroporous layer as described herein. In some embodiments, the kit may also include wire for coupling long-root plants, non-natural root fibers, or both to a macroporous layer. In some embodiments, the kit may also include a cable or tether configured to be coupled to the frame. In some embodiments, the kit may also include an anchor.

### BRIEF DESCRIPTION OF DRAWINGS

FIG. 1 is a flowchart of an embodiment of a method.

FIG. 2 is an illustration of an embodiment of an apparatus.

FIG. 3 is a cross-section illustration of an embodiment of an apparatus with a natural (organic) root system.

FIG. 4 is a cross-section illustration of an embodiment of an apparatus with an artificial root system.

FIGS. 5A and 5B are cross-section illustration of embodiments of artificial roots.

FIG. 6 is an illustration of an embodiment of a system.

### DETAILED DESCRIPTION

In some embodiments, a method, apparatus, system, or kit for removing microplastics from a body of water may be provided. These embodiments may best be understood with respect to the Figures.

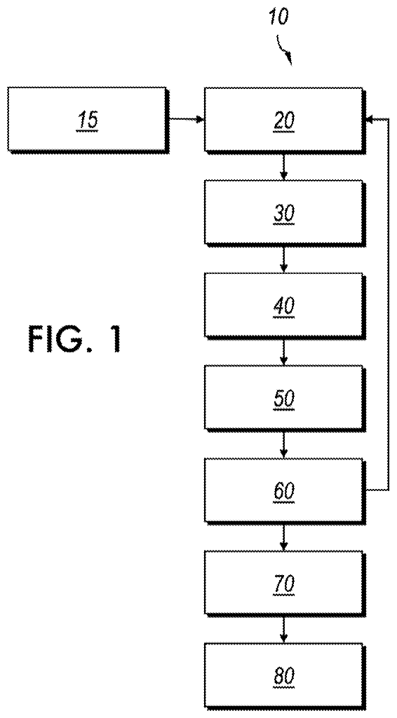

As seen in FIG. 1, the method 10 may include providing 15 at least one apparatus and positioning it in a body of water comprising microplastics, where the apparatus is coupled to an anchor.

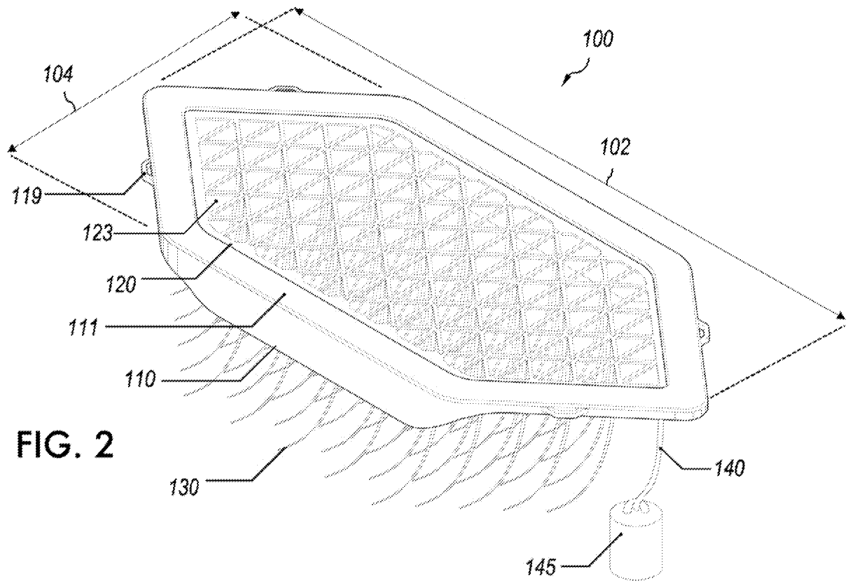

As seen in FIG. 2, an apparatus 100 may include a frame 110 and a root network 130. The root network is removably coupled to the frame. A macroporous layer 120 may be present, where macroporous layer is removably coupled to the frame 110. In some embodiments, the root network may be coupled or removably coupled to the macroporous layer. The apparatus may have a cable or tether 140 that is removably attached to the frame 110. One end of the cable or tether 140 may be attached to an anchor 145.

### Frame

In some embodiments, the frame may have a length 102 and a width 104. In some embodiments, the length is at least 1, 2, 3, or 4 meters and is no more than 4, 5, 6, or 7 meters, including all combinations and subranges thereof. In some embodiments, the frame has a length of 2-6 meters. In some embodiments, the frame has a length of 3-5 meters. In some embodiments, the width is at least 0.5, 1, 1.5, or 2 meters and no more than 2, 2.5, 3, or 3.5 meters, including all combinations and subranges thereof. In some embodiments, the width is 1-3 meters.

In some embodiments, the frame may have a top surface 111 that is configured to have an external geometric shape with 3-8 sides. In some embodiments, the frame may have 6 sides. In some embodiments, the macroporous layer is configured to have the same external geometric shape as the top surface of the frame. That is, an external surface of the macroporous layer 120 may define a hexagonal shape and the frame may also define a hexagonal shape. In some embodiments, the macroporous layer has a different shape than the frame (such as a circular macroporous layer and a rectangular frame).

In some embodiments, the frame may include one or more extensions 119 that extend away from the frame and form a lift point (e.g., to carry, hold, or manipulate the apparatus) or an attachment point (e.g., to allow a rope or tie to attach to the frame). In some embodiments, the extensions may be configured to be above a surface of the water.

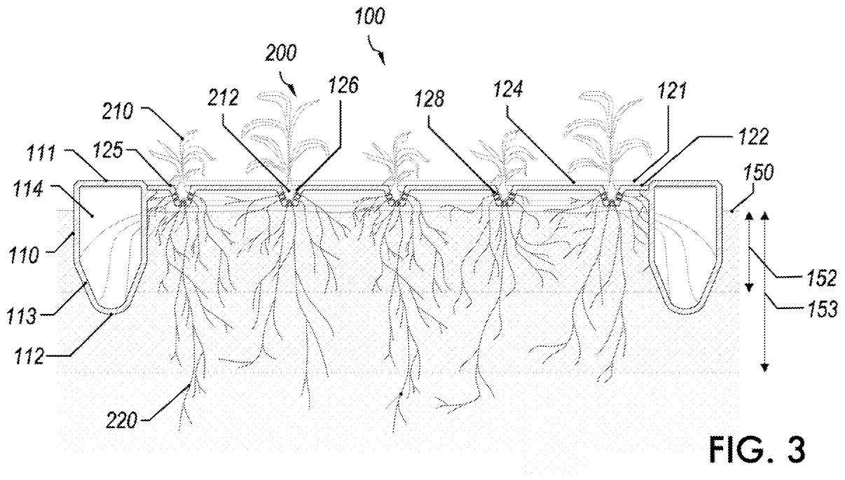

Referring to FIG. 3, in some embodiments, the frame 110 is comprised of one or more layers 113 that define atop surface 111 that is configured to be above a surface 150 of a body of water, and a bottom surface 112 configured to be at least partially below the surface 150 of the body of water. In some embodiments, the bottom surface is configured to be entirely below the surface of the water. The one or more layers 113 may define one or more internal cavities 114 allowing the frame to act as a pontoon structure. In some embodiments, the frame is a single material. In some embodiments, the frame is a composite structure. In some embodiments, the frame may utilize fiberglass, carbon fiber, a cross laminated timber, an inflatable bladder, or a combination thereof.

In some embodiments, the depth (the maximum distance from a top surface 111 to a bottom surface 112) is at least 0.1, 0.2, or 0.3 meter and no more than 0.4, 0.5, 0.6, 0.7, 0.8, 0.9. or 1 meter, including all combinations and subranges thereof. In some embodiments, the depth is no more than 0.25, 0.5, or 0.75 meters. In some embodiments, the depth is 0.1-0.5 meters. In some embodiments, the distance from the top surface 111 to the bottom surface 112 is less than 2 feet, less than 1.5 feet, or less than 1 foot.

In some embodiments, the bottom surface 112 is configured to have one or more anchor points. Such anchor points are configured to allow the frame to be coupled to an anchor 145 or a fixed structure. In some embodiments, the anchor point is a port extending through a portion of the frame. In some embodiments, the cable or tether may be configured to pass through the port. In some embodiments, a carabiner may be used to removably attach the tether or cable to the frame, using the port. In some embodiments, a bolt is used to anchor the cable or tether in place at the anchor point. In some embodiments, the anchor is a weighted anchor. In some embodiments, each anchor is between 5 and 50 pounds. In some embodiments, an anchor may be configured to be placed underwater on the floor of the body of water in which the apparatus is positioned. In some embodiments, an anchor may be configured to be placed on the bank of a body of water in which the apparatus is placed.

In some embodiments, the anchor points are configured to be connected to an anchor via a tether 140. In some embodiments, the frame comprises a plurality of anchor points. In some embodiments, the frame comprises a single anchor point. In some embodiments, the tether may be comprised of a metal wire, cable, or chain, which is may be coated. In some embodiments, the tether may be comprised of a polymeric rope. In some embodiments, each anchor point is coupled to a different anchor. In some embodiments, two or more anchor points are coupled to a same anchor.

### Macroporous Layer

Referring to FIGS. 2 and 3, the macroporous layer 120 is configured to be removably coupled to the frame 110. The macroporous layer may comprise one or more layers 124, 125.

In some embodiments, at least a first layer 124 has a top surface 121 and a bottom surface 122, and the layer defines a plurality of openings extending from the top surface to the bottom surface. In some embodiments, each opening may have a maximum characteristic dimension (e.g., diameter, length, or width, etc., depending on the shape of the opening) of from 0.5 inches to 6 inches.

In some embodiments, the macroporous layer may include a plant root housing manifold layer 125. The plant root housing manifold layer may be positioned below the first layer 124. The plant root housing manifold layer is configured to hold a portion 212 of a plant that forms the natural or organic root system 200 in place on the apparatus. For example, in some embodiments, the plant root housing manifold layer defines a plurality of depressions 126 into which a portion 212 of one or more plants is positioned, allowing a top portion 210 to extend upwards through the first layer 124 while the root structure 220 extends downward below the surface 150 of the body of water, where the roots extend through openings 128 in the manifold.

In some embodiments, a growing medium layer may be present in or on the macroporous layer. In some embodiments, the growing medium layer may be present on a top surface of the first layer 124 or one a top surface of a plant root housing manifold. For example, in some embodiments, a growing medium is provided in each depression 126 of a manifold.

The growing medium may be any appropriate growing medium as understood in the art. For example, in some embodiments, the growing medium may include, e.g., coir or mineral soils. In some embodiments, the growing medium may include a soilless medium.

In some embodiments, the macroporous layer is a composite structure. In some embodiments, the macroporous layer may comprise or consist of fiberglass, carbon fiber, an array of wires, cross-laminated timber, or a combination thereof.

### Root Network

The root network may be a natural (organic) root network, an artificial or non-natural root network, a plurality of fiber filters, or a combination thereof. In some embodiments, the root network comprises or consists of a natural root network and an artificial root network. In some embodiments, the root network comprises or consists of an artificial root network and a plurality of fiber filters. In some embodiments, the root network comprises or consists of a natural (organic) root network, an artificial or non-natural root network, and a plurality of fiber filters.

### Natural Root Network

FIG. 3 provides a cross-sectional view of a frame and a natural (organic) root network 200. As seen in FIG. 3, the natural root network may comprise a plurality of roots 220 of long-root plants. The long-root plants may be any appropriate long-root plant as understood in the art, including, e.g., a sedge, arrow arum, or both. The roots 220 are coupled to the macroporous layer 120 as disclosed herein. In some embodiments, a portion 212 of each long-root plant is within a plant root housing manifold. In some embodiments, a portion 212 of each long-root plant is attached to the macroporous layer 120 via a wire, twine, clamps, or other removable coupling device (not shown).

As seen in FIG. 3, the roots may extend some distance 152, 153 below the surface 150 of a body of water. In some embodiments, the roots extend below the furthest submerged bottom surface 112 of the frame. In some embodiments, at least some roots extend less than a first distance 152 below the surface 150. In some embodiments, the first distance is between 10 and 14 inches, such as 12 inches. In some embodiments, at least some roots extend between the first distance 152 and a second distance 153. In some embodiments, the second distance is between 20 and 28 inches, such as 24 inches. In some embodiments, at least some roots extend more than the second distance, such as up to 36 or 48 inches.

### Artificial Root Network

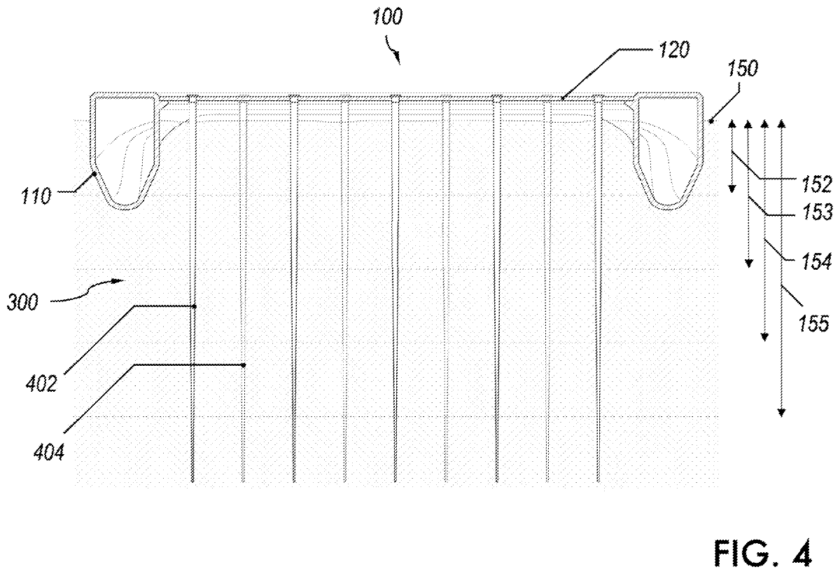

FIG. 4 provides a cross-sectional view of a frame 110 and an artificial root network 300 coupled to a macroporous layer 120.

The artificial root network 300 may include a plurality of artificial roots 402, 404. As seen in FIG. 4, the artificial roots may extend some distance 152, 153, 154, 155 below the surface 150 of a body of water. In some embodiments, at least some roots extend less than a first distance 152 below the surface 150. In some embodiments, the first distance is between 10 and 14 inches, such as 12 inches. In some embodiments, at least some roots extend between the first distance 152 and a second distance 153. In some embodiments, the second distance is between 20 and 28 inches, such as 24 inches. In some embodiments, at least some roots extend between the second distance 153 and a third distance 154. In some embodiments, the third distance is between 32 and 40 inches, such as 36 inches. In some embodiments, at least some roots extend between the third distance 154 and a fourth distance 155. In some embodiments, the fourth distance is between 44 and 52 inches, such as 48 inches. In some embodiments, at least some roots extend more than the fifth distance, such as up to 60 or 72 inches.

The artificial roots may be of one or more types or designs of roots. In some embodiments, each artificial root is the same type or design. In some embodiments, each artificial root is one of a plurality of types or designs.

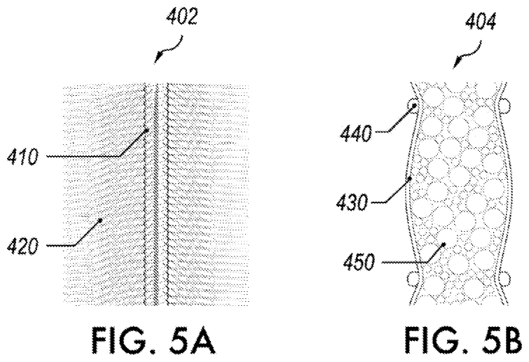

Referring to FIG. 5A, one type or design of artificial root 402 can be seen. In this design, a metal wire 410 (such as a steel wire), which may be treated or coated to prevent interaction with the body of water provides a central structure for each root, while fibrous structures 420 are coupled to the wire (e.g., adhered, tied, etc.). In preferred embodiments, the points at which the coconut fibers are attached to the wire are offset circumferentially and/or axially from each other. The fibrous structures may be natural in origin. For example, in some embodiments, the fibrous structures utilize coir, and preferably coconut fibers. In some embodiments, the fibrous structures are free of polymers.

Referring to FIG. 5B, a second type or design of artificial root 404 can be seen. In this design, a porous fibrous fabric 430 is formed in a substantially elongated cylindrical shape, the forming an internal volume of space. The porous fibrous fabric may be a woven or nonwoven material. In some embodiments, the porous fibrous fabric may be a cotton fabric or burlap. In some embodiments, a cord 440 may be wrapped around an external surface of the porous fibrous fabric to help maintain its shape and provide some strength. The cord may be, e.g., a metal wire, or a natural or artificial material. In some embodiments, the cord is a hemp rope. In some embodiments, one or more materials may be present in the internal volume. In some embodiments, an adsorbent material, such as activated charcoal, may be utilized.

### Fiber Filters

In some embodiments, the root network may include one or more fiber filters. The fiber filters may be commercially available filters. In some embodiments, the filters may be fitted into slots on the frame. The filters may be coupled to a macroporous layer.

In some embodiments, 3-15 fiber filters are arranged to extend below the surface of the water.

In some embodiments, the plurality of fiber filters are configured such that each fiber filter has a filtration surface that is normal to an expected direction of flow of the body of water, and each fiber filter is offset in a direction parallel to the expected direction of flow of the body of water from at least one other fiber filter by an equal distance.

In some embodiments, the root networks are configured such that no root touches the bottom of the body of water in which it is positioned. For example, is the apparatus is to be positioned in a river with a depth of 72 inches, the root network may be configured such that the roots do not extend the full 72 inches into the water. In some embodiments, the root network extends no more than 40%, 50%, 60%, 70%, or 80% of the depth of the body of water in which the platform is utilized.

Referring again to FIG. 1, the method 10 may include allowing 20 the body of water comprising microplastics to flow past the root network of the at least one apparatus coupled to an anchor.

The method 10 may also include allowing the root network to physically entangle 30 the microplastics. That is, care should be taken to avoid any water treatment or physical manipulation of the body of water that prevents the roots from being able to capture microplastics.

The method 10 may also include removing 40 the root network from the at least one apparatus. In some embodiments, this may include unscrewing, or otherwise detaching the macroporous layer from the frame, lifting the frame (which is coupled to the root network) away from the frame, and preferably moving the macroporous layer and root network away from the body of water. In some embodiments, the macroporous layer may include handholds or lift points configured to allow the macroporous layer to be more easily removed.

In some embodiments, the method 10 may include removing 50 the microplastics from the root network. In some embodiments, this may include a chemical treatment of the root network. In some embodiments, this may include physically interacting with the root network to cause any sediment, microplastics, or other solid material physically removed from the body of water and entangled by the root network to separate from the root network. This can be done manually, e.g., either by hand or with tools such as brooms or rakes, or via an automated process such as via an automated sieving process. In some embodiments, tethers coupling a natural root network to the macroporous layer are cut, and the natural root network is either pulled out or dumped out of the macroporous layer.

In some embodiments, the method 10 may include replacing 60 the root network after the microplastics have been removed from the root network. In some embodiments, removing and replacing the root network includes removing and replacing a macroporous layer coupled to the root network.

Some or all of the previous steps may be repeated. For example, as shown in FIG. 1, the steps of allowing the water to flow past the root network through replacing the root network are repeated at least once.

In some embodiments, the method 10 may include performing 70 an analysis of a sample of the material physically entangled by the root network. For example, after the step of removing 50 the microplastics from the root network, a sample of all material removed from the root network may be analyzed to determine how much microplastic was captured, and/or what microplastics were captured. This step may be performed at any time after the material is removed from the root network. For example, while in FIG. 1, it is shown as occurring after replacing 60 the root network, in some embodiments, this may occur before that replacement step occurs.

In some embodiments, after performing the analysis, the method 10 may include repositioning 80 the at least one apparatus based on a result of the analysis. For example, if the analysis reveals that the root network is not removing an expected amount of microplastics, or a desired amount of microplastics, a user may decide to reposition the apparatus to allow the root network to interact with a different part of the body of water. In some embodiments, this may involve moving the apparatus to a position with a different flow rate of water past the root network, and/or reorienting the apparatus with respect to the body of water. This step may be performed at any time after the analysis is performed. For example, while in FIG. 1, it is shown as occurring after replacing 60 the root network, in some embodiments, this may occur before that replacement step occurs. Alternatively, in some embodiments, the analysis 70 may occur before replacing 60 the root network, while repositioning 80 may occur after replacing the root network.

In some embodiments, a system is provided.

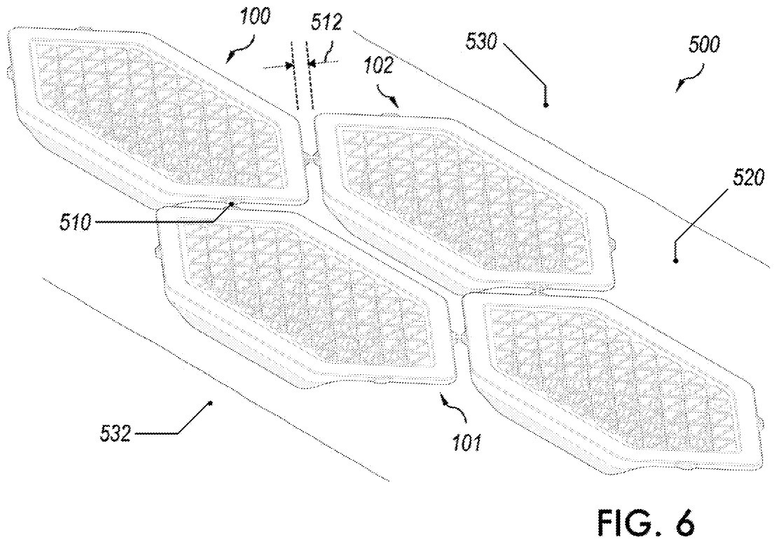

This can be seen in FIG. 6, where a system 500 is seen in a body of water (here, a river 520) between a first and second plots of land 530, 532 (here, riverbeds) and a second riverbank 532. The system 500 includes a plurality of floating platforms positioned in the same body of water, each floating platform being an apparatus 100, 101, 102 as disclosed herein.

In some embodiments, each floating platform is physically in contact with at least one other floating platform. In some embodiments, each floating platform is physically separated from all other floating platforms.

In some embodiments, each floating platform (e.g., apparatus 100) is physically separated from at least one other floating platform (e.g., apparatus 102) by a distance 512. In some embodiments, that distance is at least half of a width of each floating platform and no more than twice the length of each floating platform. In embodiments where each platform is a different size, that distance may be at least half of a width of the widest floating platform and no more than twice the length of the longest floating platform.

In some embodiments, two or more of the plurality of floating platforms (e.g., apparatus 100 and apparatus 101) are connected via a tether system 510. The tether system may include, e.g., a wire tether, a hemp rope tether, a polymeric tether, or a combination thereof.

In some embodiments, the floating platforms are configured such that extensions 119 on each floating platform are in contact with each other, but the remainder of the frame is not in contact with any other floating platform. For example, a nylon zip-tie may connect the extension of one platform to another, where only a portion of each extension is in contact, and no other part of the frame touches another frame.

In some embodiments, a kit is provided. The kit may include a frame as disclosed herein, and a root network configured to be operably coupled to the frame and extending below the frame. The frame may be any frame as disclosed herein. The root network may be any root network as disclosed herein.

In some embodiments, the kit may also include a macroporous layer as described herein.

In some embodiments, the kit may also include wire for coupling long-root plants, non-natural root fibers, or both to a macroporous layer.

In some embodiments, the kit may also include a cable or tether configured to be coupled to the frame.

In some embodiments, the kit may also include an anchor.

### Example 1—Efficacy of Root System

A selection of 5 water lettuce plants were exposed, in a laboratory setting, to a recirculating stream of water containing a known quantity of fluorescent microplastics. After 8 hours of exposure to the stream, the aquatic roots had captured 70% of the microplastics in the stream.

A 6-inch-long artificial root, comprised of a steel wire and an array of coconut fibers each approximately 50 mm in length, was exposed, in a laboratory setting, to a recirculating stream of water containing a known quantity of fluorescent microplastics. After 30 minutes of exposure to the stream, the artificial root had captured 33% of the microplastics in the stream.

### Example 2—Apparatus Design

A ¼ scale prototype featuring a hexagonal pontoon frame, measuring 40 inches in length, 20 inches in width, and 4-inches-in depth was formed using molded fiberglass coated with epoxy resin. The macroporous layer was formed from laser cut cross laminated timber coated with epoxy resin. The macroporous layer had an array of 1 inch×½ inch triangular holes cut through the layer. An artificial root network containing 18 artificial roots was coupled to the macroporous layer. Each root contains a 6 inch long, 3 mm diameter steel wire bolted to the macroporous layer, with an array of coconut fibers adhered at one end to the wire, each fiber being approximately 50 mm in length.

Embodiments of the present disclosure are described in detail with reference to the figures wherein like reference numerals identify similar or identical elements. It is to be understood that the disclosed embodiments are merely examples of the disclosure, which may be embodied in various forms. Well known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Those skilled in the art will recognize or be able to ascertain using no more than routine experimentation many equivalents to the specific embodiments of the invention described herein. Such equivalents are intended to be encompassed by the following claims.

1. A method for removing microplastics from a body of water, comprising:
a. allowing a body of water comprising microplastics to flow past a root network of at least one apparatus coupled to an anchor, each at least one apparatus comprising:
a frame, the frame having a top surface and a bottom surface, the bottom surface of the frame defining at least one anchor point coupled to the anchor, the frame configured to keep at least a portion of the top surface of the frame above a top surface of the body of water;
a root network operably coupled to the frame and extending below the frame, where the root network comprises:
a plurality of roots of long-root plants coupled to a macroporous layer, the macroporous layer comprising an array of holes extending from a top surface to a bottom surface, the macroporous layer being removably attached to the frame;
a plurality of non-root natural fibers coupled to a macroporous layer, the macroporous layer comprising an array of holes extending from a top surface to a bottom surface, the macroporous layer being removably attached to the frame;
a plurality of filters; or
a combination thereof;
b. allowing the microplastics to be physically entangled by the root network; and
c. removing the root network from the at least one apparatus.

2. The method according to claim 1, wherein the long-root plants or non-root natural fibers are coupled to the macroporous layer via one or more wires,
wherein the macroporous layer is a first composite structure and optionally the first composite structure comprises fiberglass, carbon fiber, a wire array, cross-laminated timber, or a combination thereof,
wherein the frame is a second composite structure and optionally the composite structure comprises fiberglass, carbon fiber, a cross laminated timber, an inflatable bladder, or a combination thereof,
wherein the long-root plants comprise a sedge, arrow arum, or both, and/or
wherein the non-root natural fibers comprise coir,
wherein each hole in the array of holes has a diameter of between 0.5 inches and 6 inches,
wherein the at least one apparatus further comprises a growing medium layer on a top surface of the macroporous layer,
wherein the plurality of fiber filters comprises between 3 and 15 fiber filters removably coupled to the frame, and/or
wherein the plurality of fiber filters are configured such that each fiber filter has a filtration surface that is normal to an expected direction of flow of the body of water, and each fiber filter is offset in a direction parallel to the expected direction of flow of the body of water from at least one other fiber filter by an equal distance.

3-6. (canceled)

7. The method according to claim 2, wherein the growing medium layer comprises coir or mineral soils.

8. The method according to claim 2, wherein the growing medium layer is a soilless medium.

9. The method according to claim 1, further comprising:
d. replacing the root network after the microplastics have been removed from the root network; and
e. repeating steps a-d.

10. The method according to claim 9, wherein removing and replacing the root network includes removing and replacing a macroporous layer coupled to the root network.

11-19. (canceled)

20. The method according to claim 1, further comprising removing material physically entangled by the root network.

21. The method according to claim 20, further comprising performing an analysis of a sample of the material physically entangled by the root network.

22. The method according to claim 21, further comprising repositioning the at least one apparatus based on a result of the analysis.

23. An apparatus, comprising:
a frame, the frame having a top surface and a bottom surface, the frame defining at least one anchor point, the frame configured to keep at least a portion of the top surface of the frame above water when the device is placed in water;
a root network operably coupled to the frame and extending below the frame, where the root network comprises:
a plurality of roots of long-root plants coupled to a macroporous layer, the macroporous layer comprising an array of holes extending from a top surface to a bottom surface, the macroporous layer being removably attached to the frame;
a plurality of non-root natural fibers coupled to a macroporous layer, the macroporous layer comprising an array of holes extending from a top surface to a bottom surface, the macroporous layer being removably attached to the frame;
a plurality of filters; or
a combination thereof.

24. The apparatus according to claim 23, wherein the long-root plants or non-root natural fibers are coupled to the macroporous layer via one or more wires,
wherein the macroporous layer is comprised of a rigid or semi-rigid composite structure,
wherein each hole in the array of holes has a diameter of between 0.5 and 6 inches,
wherein the long-root plants comprise a sedge, arrow arum, or both,
wherein the non-root natural fibers comprise coir;
wherein the top surface of the frame is configured to have an external geometric shape with 3-8 sides, and/or
wherein the frame comprises fiberglass, carbon fiber, a cross laminated timber, an inflatable bladder, or a combination thereof.
wherein the plurality of fiber filters comprises between 3 and 10 fiber filters removably coupled to the frame.

25-26. (canceled)

27. The apparatus according to claim 23, further comprising a growing medium layer on a top surface of the macroporous layer.

28. The apparatus according to claim 27, wherein the growing medium layer comprises coir or peat moss, and/or
wherein the growing medium layer is a soilless medium.

29-32. (canceled)

33. The apparatus according to claim 23, wherein the plurality of fiber filters are configured such that each fiber filter has a filtration surface that is normal to an expected direction of flow of a body of water around the apparatus, and each fiber filter is offset in a direction parallel to the expected direction of flow from at least one other fiber filter by an equal distance.

34. (canceled)

35. The apparatus according to claim 23, further comprising at least one cable attached to the at least one anchor point, and optionally at least one anchor attached to an end of the at least one cable.

36-37. (canceled)

38. A system, comprising:
a plurality of floating platforms positioned in the same body of water, each floating platform being an apparatus according to claim 23.

39. The system according to claim 38, wherein each floating platform of the plurality of floating platforms is physically in contact with at least one other floating platform of the plurality of floating platforms.

40. The system according to claim 38, wherein each floating platform of the plurality of floating platforms is physically separated from all other floating platforms of the plurality of floating platforms.

41. The system according to claim 40, wherein each floating platform of the plurality of floating platforms is physically separated from at least one other floating platform of the plurality of floating platforms by a distance that is at least half a width of each floating platform and no more than twice the length of each floating platform.

42-43. (canceled)

44. A kit, comprising:
a frame, the frame having a top surface and a bottom surface, the bottom surface of the frame defining at least one anchor point, the frame configured to keep at least a portion of the top surface of the frame above water when the device is placed in water;
a root network configured to be operably coupled to the frame and extending below the frame, where the root network comprises:
a plurality of long-root plants;
a plurality of non-root natural fibers;
a plurality of filters; or
a combination thereof.

45-48. (canceled)
